(19) United States
(12) Patent Application Publication
(10) Pub. No.: US 2007/0252956 A1
(43) Pub. Date: Nov. 1, 2007

(54) Projection type display apparatus

(75) Inventors: Muneharu Kuwata, Tokyo (JP); Tomohiro Sasagawa, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 11/790,256

(22) Filed: Apr. 24, 2007

(30) Foreign Application Priority Data
Apr. 25, 2006 (JP) 2006-120478
Oct. 27, 2006 (JP) 2006-292349

(51) Int. Cl. G03B 21/14

(52) U.S. Cl. 353/69; 353/77

(57) ABSTRACT

In a projection type display apparatus includes an illumination device (including a light source), a light modulation element, a projection optical system that projects a modulated light from the light modulation element, and a screen onto which a projected light is projected. The projection optical system includes a refraction type optical system that refracts the modulated light from the light modulation element, and a hologram element disposed on a position remote from the screen and shifted in a direction parallel to the screen from a center of the screen. The hologram element projects the modulated light having passed through the refraction type optical system onto the screen so that a light ray of the center of the modulated light is inclined with respect to a normal line of the screen.

### BACKGROUND OF THE INVENTION

This invention relates to a projection type display apparatus that projects an image formed by a light modulation element onto a screen in an enlarged manner.

Conventionally, there is proposed a display apparatus configured to use a power mirror to obliquely project an image formed by a light valve (as a light modulation element) onto a screen in an enlarged manner (see, for example, Patent Documents 1 through 3).

Further, there is proposed a display apparatus configured to use a hologram sheet to cause a light from a projection device to be incident on a screen at an angle approximately perpendicular to the screen (see, for example, Patent Document 4).

Patent Document 1: Japanese Laid-Open Patent Publication No. 2004-157560 (FIG. 1)

Patent Document 2: Japanese Laid-Open Patent Publication No. 2002-207168 (FIG. 39)

Patent Document 3: International Publication No. 01/06295 (FIG. 20)

Patent Document 4: Japanese Laid-Open Patent Publication No. HEI 8-248514 (FIGS. 1 and 2)

In the display apparatus disclosed in the Patent Documents 1 through 3, in order to thin a display apparatus (i.e., to reduce the depth dimension of the display apparatus), it is necessary to shorten the distance from the power mirror to the screen. However, in order to shorten the distance from the power mirror to the screen, it is necessary to widen the angle of view of a projected light from the power mirror, with the result that the curvature of the power mirror becomes large. Since the curvature of the power mirror needs to be large for shortening the distance from the power mirror to the screen, the depth dimension (i.e., the thickness) of the power mirror itself increases. Therefore, the display apparatus disclosed in the Patent Documents 1 through 3 has a problem that the thinning of the display apparatus is limited by the depth dimension of the power lens itself.

Further, it can be considered that the display apparatus is thinned by reducing the depth dimension of the power mirror itself, by means of miniaturization of the power mirror itself. However, when the power mirror having an aspheric surface or a free surface is miniaturized, a distortion aberration is not sufficiently corrected (compared with the case where a large power mirror is used), and causes another problem that an image quality is degraded. Moreover, in order to sufficiently correct the distortion aberration that occurs when the angle of view is wide, it is necessary to use a large power mirror having a complicated shape such as an aspheric surface or a free surface. Such a power mirror is difficult to manufacture, and therefore a manufacturing cost increases.

Furthermore, the display apparatus disclosed in Patent Document 4 needs a large hologram sheet whose size is almost the same as the screen, and it is difficult to manufacture such a large hologram sheet.

### SUMMARY OF THE INVENTION

The present invention is intended to solve the above described problems, and an object of the present invention is to provide a projection type display apparatus capable of reducing the depth dimension and having a simple configuration, without degrading the image quality.

The present invention provides a projection type display apparatus including an illumination device (including a light source), a light modulation element to which image signal is inputted and which modulates a light from the illumination device according to the image signal, a projection optical system which projects a modulated light from the light modulation element in an enlarged manner, and a screen onto which a projected light from the projection optical system is projected so that image is displayed thereon. The projection optical system includes a refraction type optical system which refracts the modulated light from the light modulation element, and a hologram element disposed on a position remote from the screen and shifted in a direction parallel to the screen from a center of the screen. The hologram element projects the modulated light having passed through the refraction type optical system onto the screen so that a light ray of the center of the modulated light is inclined with respect to a normal line of the screen.

With such an arrangement, it becomes possible to reduce the depth dimension of the projection type display apparatus with a simple configuration, without degrading the image quality.

### BRIEF DESCRIPTION OF THE DRAWINGS

In the Attached Drawings:

FIG. 1 is a side view schematically showing a configuration and a light path of a projection type display apparatus according to Embodiment 1 of the present invention;

FIG. 2 is a side view schematically showing a configuration and a light path of a projection type display apparatus according to Embodiment 2 of the present invention;

FIG. 3 is a side view schematically showing a configuration and a light path of a projection type display apparatus of Comparative Example;

FIG. 4 is a top view schematically showing a configuration and a light path of a projection type display apparatus according to Embodiment 3 of the present invention;

FIG. 5 is a side view schematically showing the configuration and the light path of the projection type display apparatus of according to Embodiment 3 of the present invention, and

FIG. 6 is a side view schematically showing a configuration and a light path of a projection type display apparatus of Comparative Example.

### DETAILED DESCRIPTION OF THE PREFERRED EMBODIMENT

Embodiments of the present invention will be described with reference to the attached drawings.

### Embodiment 1

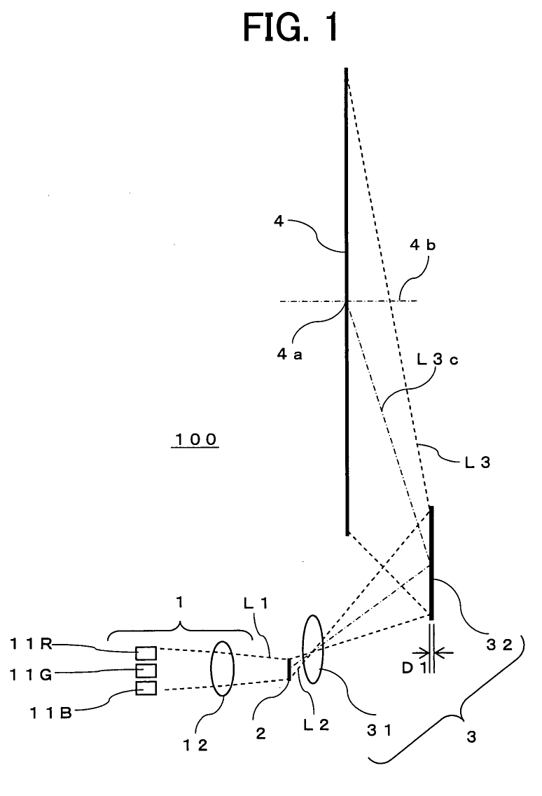

FIG. 1 is a side view schematically showing a configuration and a light path of a projection type display apparatus 100 according to Embodiment 1 of the present invention. The projection type display apparatus 100 is, for example, a rear projection television. FIG. 1 shows the interior of the projection type display apparatus 100 as seen from the side.

As shown in FIG. 1, the projection type display apparatus 100 according to Embodiment 1 includes an illumination device 1, a light modulation element (i.e., a light valve) 2 to which image signal is inputted and which modulates a light L1 from the illumination device 1 according to the image signal, a projection optical system 3 that projects the modulated light L2 from the light modulation element 2 in an enlarged manner, and a screen 4 onto which the projected light L3 from the projection optical system 3 is projected.

The illumination device 1 includes a plurality of laser light sources 11R, 11G and 11B and an illumination optical system 12. In FIG. 1, three kinds of laser light sources 11R, 11G and 11B that emit laser beams of different wavelength bands (for example, red, green and blue) are shown. It is also possible to add a laser light source whose wavelength is different from the laser light sources 11R, 11G and 11B, and it is also possible to reduce the number of laser light sources. The number and the types of the laser light source are not limited to the example shown in FIG. 1. Although an optical lens is shown as the illumination optical system 12 in FIG. 1, the configuration of the illumination optical system 12 is not limited to the example shown in FIG. 1, but other configuration (for example, a mirror or other kind of lens) can be employed. Further, the illumination device 1 can be configured to include a light intensity uniformizing element that uniformizes the intensity of the emitted light L1 in a plane perpendicular to the light ray of center of the light L1. As the light intensity uniformizing element, it is possible to employ, for example, an integrator rod or a hollow light pipe that utilizes multiple reflection of light, or a fly's-eye lens that divides the light from the light source 11 into a plurality of sections (such as rectangular sections) and superposes the divided lights. Further, the illumination device 1 can be configured to include a color wheel for displaying a color image in time division, a dichroic mirror for color composition, or the like.

The light modulation element 2 modulates the light L1 from the illumination device 1 in accordance with the image signal. As the light modulation element 2, it is possible to use a DMD (Digital Micro-mirror Device: Trademark of Texas Instrument Incorporated) that has a plurality of micro-mirrors arranged in a plane and changes the angles of the respective micro-mirrors in accordance with the image signal. Further, as the light modulation element 2, it is also possible to use other light valve such as a light-transmission type or light-reflection type liquid crystal display panel or the like. Although FIG. 1 shows a single-plate system including one light modulation element 2, it is also possible to employ a plurality of light modulation elements. For example, it is possible to employ three-plate system including three light modulation elements 2. The configuration and arrangement of the illumination device 1 and the light modulation element 2 are not limited to those shown in FIG. 1. By utilizing an optical element such as a mirror or a lens, the positions of the illumination device 1 and the light modulation element 2 can be changed to positions (for example, below the projection optical system 3) where the illumination device 1 and the light modulation element 2 do not increase the thickness (i.e., the depth dimension) of the display apparatus.

The projection optical system 3 includes a refraction type optical system 31 that refracts the modulated light L2 from the light modulation element 2, and a light-reflection type hologram element 32. The refraction type optical system 31 is composed of, for example, a plurality of lens elements having different materials and different curvatures, in order to correct respective aberrations to obtain excellent imaging performance. The hologram element 32 is disposed on a position apart from the screen 4 and shifted in the direction parallel to the screen 4 (downward in FIG. 1) from a center position 4a of the screen 4. The hologram element 32 projects the modulated light L3 (having passed through the refraction type optical system 31) toward the screen 4 in such a manner that the center light ray L3c of the modulated light L3 having passed through the refraction type optical system 31 is inclined with respect to a normal line 4b of the screen 4.

The hologram element 32 is manufactured as follows: A laser beam having high coherency is divided into two, using a beam splitter or the like. One of the divided beams is irradiated directly to a photosensitive surface as a reference light. The other of the divided beams is irradiated to an object so that the reflected light from the object is irradiated to the photosensitive surface as an object light. With this, the intensity distribution of the interference fringe formed by the reference light and the object light is recorded on the photosensitive surface. By developing the photosensitive surface, the hologram element 32 is obtained. When the light (as a reproducing illumination light) is incident on the hologram element 32, the light is diffracted by the interference fringe recorded on the hologram, and the reflection light (used when the object light has been produced) is reproduced. The light-reflection type hologram element 32 of Embodiment 1 is a hologram element manufactured on this principle using a power mirror as the object. Therefore, when the light is incident on the light-reflection type hologram element 32, the hologram element 32 reflects the incident light in a specified direction in accordance with the incident angle on the hologram element 32 (having the planar shape) so as to satisfy desired imaging performance and desired distortion performance, in a similar manner to the case where the light is incident on the power mirror.

Further, the hologram element 32 has characteristics that the diffraction efficiency is at the maximum when the light whose wavelength band is the same as the light source used in the manufacturing process of the hologram element 32 is incident on the hologram element 32, and when the incident angle on the hologram element 32 is the same as that in the manufacturing process of the hologram element 32. Therefore, the efficiency can be enhanced when the laser beam having the high coherency is used as the reproducing illumination light. The hologram element 32 having the planar shape according to Embodiment 1 can be manufactured, for example, by a method using one photosensitive surface having sensitivity to all wavelength bands of the light sources 11R, 11G and 11B, and using a multiple exposure by sequentially switching the light sources 11R, 11G and 11B. Further, the hologram element 32 can be manufactured by a method using a plurality of photosensitive surfaces (overlapping with each other) each having a sensitivity only to one of the wavelength bands of the light sources 11R, 11G and 11B, and using a multiple exposure by sequentially switching the light sources 11R, 11G and 11B, or can be manufactured by other method. When the hologram element 32 is manufactured using three light sources each having the same wavelength band as a respective one of the light sources 11R, 11G and 11B, the diffraction efficiency is at the maximum when the lights having the same wavelength bans as the light sources 11R, 11G and 11B are incident on the hologram element 32. Therefore, when the white light source such as a lamp or the like having a continuous spectrum is used in the illumination device 1, the reflection efficiency to the wavelength bands of the light sources 11R, 11G and 11B is high, but the reflection efficiency to the wavelength bands other than those, of the light sources 11R, 11G and 11B (i.e., the majority of the wavelength bands) is low, with the result that the reflection efficiency throughout the spectrum band is low. In contrast, when the light sources 11R, 11G and 11B having the same wavelengths as the exposure light sources used in the manufacturing process of the hologram element, high reflection efficiency can be obtained to any of the wavelength bands, and therefore bright and sharp image can be obtained. Moreover, the light-reflection type hologram element 32 of Embodiment 1 having the planar shape does not have a large size nor a complicated shape such as an aspheric surface and a free surface of the power mirror, and therefore the hologram element 32 can be easily manufactured using a mold such as an injection molding or the like.

The screen 4 is, for example, a light-transmission type screen. The projected light L3 from the projection optical system 3 is projected onto the screen 4, so that the image is displayed thereon.

Next, the operation of the projection type display apparatus 100 will be described. The light from the light source (the light sources 11R, 11G and 11B) is refracted or reflected by the illumination optical system 12, and is irradiated to the light modulation element 2, so that the light modulation element 2 is illuminated. The light modulation element 2 modulates the light L1 from the illumination device 1 (including the light sources 11R, 11G and 11B and the illumination optical system 12) in accordance with the image signal. The modulated light L2 from the light modulation element 2 is incident on the refraction type optical system 31, refracted by the refraction type optical system 31, and is reflected by the light-reflection type hologram 32 (having the planar shape) in an enlarged manner. The projected light L3 from the projection optical system 3 (including the refraction type optical system 31 and the light-reflection type hologram element 32 having the planar shape) is incident on the screen 4 obliquely from below in FIG. 1 so that the image is displayed thereon.

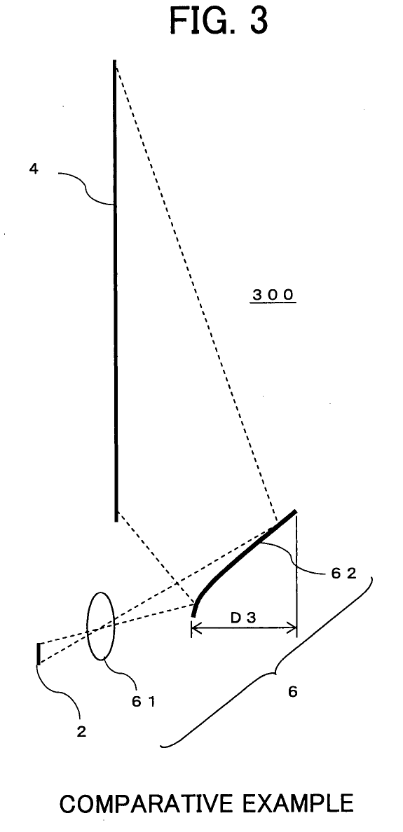

FIG. 3 is a side view showing a configuration and a light path of a projection type display apparatus 300 of Comparative Example. As shown in FIG. 3, in the projection type display apparatus of Comparative Example, the modulated light modulated by the light modulation element 2 is incident on and refracted by the refraction type optical system 61 of the projection optical system 6, is projected onto the screen 4 by the power mirror 62 of the projection optical system 6 in an enlarged manner. In order to thin the projection type display apparatus 300 (i.e., in order to reduce the depth dimension), it is necessary to shorten the distance from the power mirror 62 to the screen 4. However, in order to shorten the distance from the power mirror 62 to the screen 4, it is necessary to widen the angle of view of the projected light from the power mirror 62, with the result that the curvature of the power mirror 62 needs to be large. Therefore, in order to shorten the distance from the power mirror 62 to the screen 4, the curvature of the power mirror 62 needs to be large, and therefore the depth dimension D3 of the power mirror 62 itself increases. Accordingly, the reduction of the depth dimension of the projection type display apparatus 300 is limited by the depth dimension D3 of the power lens 62 itself. Further, it can be considered that the reduction of the depth dimension of the projection type display apparatus 300 is accomplished by reducing the depth dimension D3 of the power mirror 62 itself by means of miniaturization of the power mirror 62 itself. However, if the power mirror 62 having an aspheric surface or a free surface is miniaturized, a distortion aberration is not sufficiently corrected (compared with the case where a large power mirror is used), and therefore a quality of the image projected on the screen 4 is degraded.

As can be understood by comparing the projection type display apparatus 300 using the power mirror 62 of Comparative Example shown in FIG. 3 and the projection type display apparatus 100 using the hologram element 32 according to Embodiment 1 shown in FIG. 1, the projection type display apparatus 100 according to Embodiment 1 has the hologram element 32 having the depth dimension D1 (FIG. 1) thinner than the depth dimension D3 (FIG. 3) of the power mirror 62 instead of the power mirror 62. Further, the hologram element 32 of the planer shape has substantially the same optical properties as those of the power mirror 62, and is disposed substantially parallel to the screen 4. Accordingly, the depth dimension D1 of the hologram element 32 does not prevent the thinning of the projection type display apparatus 100. As a result, according to the projection type display apparatus 100 of Embodiment 1, it becomes possible to thin (i.e., to reduce the depth dimension of) the projection type display apparatus 100.

Moreover, in the projection type display apparatus 100, the depth dimension D1 of the hologram element 32 does not change even when the surface area of the hologram element 32 is increased, and therefore the distortion aberration can be excellently corrected.

Furthermore, in the projection type display apparatus 100, it becomes possible to eliminate the cause of increase in the cost due to the manufacturing of the power mirror having a complicated shape such as an aspheric surface or a free surface, and therefore the manufacturing cost can be reduced.

As described above, according to the projection type display apparatus of Embodiment 1, it becomes possible to reduce the depth dimension of the projection type display apparatus. with a simple configuration, without degrading the image quality.

### Embodiment 2

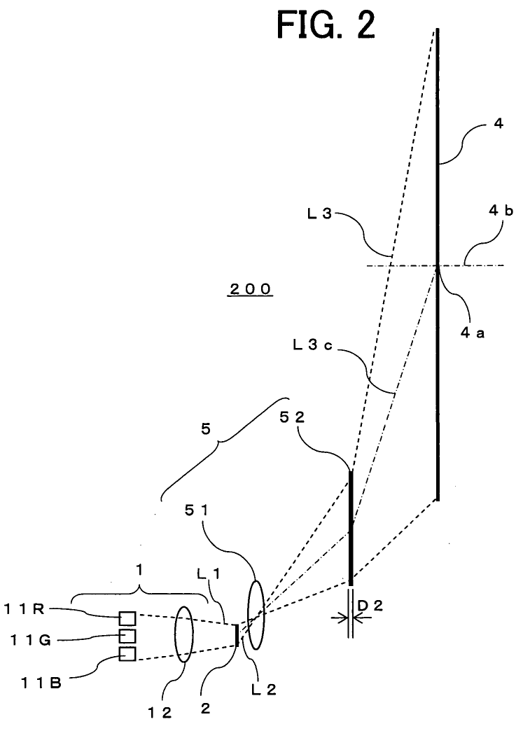

FIG. 2 is a side view schematically showing a configuration and a light path of a projection type display apparatus 200 according to Embodiment 2 of the present invention. In FIG. 2, components that are the same as or corresponding to those shown in FIG. 1 are assigned the same reference numerals.

As shown in FIG. 2, the projection type display apparatus 200 according to Embodiment 2 includes an illumination device 1, a light modulation element (i.e., a light valve) 2 to which image signal is inputted and which modulates a light L1 from the illumination device 1 according to the image signal, a projection optical system 5 that projects the modulated light L2 from the light modulation element 2, and a screen 4 onto which the light L3 from the projection optical system 5 is projected.

The projection optical system 5 includes a refraction type optical system 51 that refracts the modulated light L2 from the light modulation element 2, and a light-transmission type hologram element 52. The refraction type optical system 51 is composed of, for example, a plurality of lens elements having different materials and different curvatures, in order to correct respective aberrations to obtain excellent imaging performance. The hologram element 52 is disposed on a position apart from the screen 4 and shifted in the direction parallel to the screen 4 (downward in FIG. 2) from a center position 4a of the screen 4. The hologram element 52 projects the modulated light L3 (having passed through the refraction type optical system 51) toward the screen 4 in such a manner that the center light ray L3c of the modulated light L3 having passed through the refraction type optical system 51 is inclined with respect to a normal line 4b of the screen 4.

Next, the operation of the projection type display apparatus 200 will be described. The light from the light source (the light sources 11R, 11G and 11B) is refracted or reflected by the illumination optical system 12, and is irradiated to the light modulation element 2, so that the light modulation element 2 is illuminated. The light modulation element 2 modulates the light L1 from the illumination device 1 (including the light sources 11R, 11G an 11B and the illumination optical system 12) in accordance with the image signal. The modulated light L2 from the light modulation element 2 is incident on the refraction type optical system 51, is refracted by the refraction type optical system 51, and is enlarged by the light-transmission type hologram element 52 having the planar shape. The projected light L3 from the projection optical system 5 (including the refraction type optical system 51 and the light-transmission type hologram element 52 having the planar shape) is incident on the screen 4 obliquely from below in FIG. 2 so that the image is displayed thereon.

The hologram element 52 of Embodiment 2 is a hologram element manufactured using the power mirror as the object. When the light from the refraction type optical system 51 is incident on the hologram element 52, the hologram element 52 transmits and deflects the incident light in a specified direction in accordance with the incident angle on the hologram element 52 (having the planar shape) so as to satisfy desired imaging performance and desired distortion performance, in a similar manner to the case where the light is incident on the conventional power mirror.

The projection type display apparatus 200 of Embodiment 2 has the hologram element 52 having the depth dimension D2 (FIG. 2) instead of the power mirror whose depth dimension is thick. Further, the hologram element 52 of the planer shape has substantially the same optical properties as those of the power mirror, and is disposed substantially parallel to the screen 4. Accordingly, the depth dimension D2 of the hologram element 52 does not prevent the thinning of the projection type display apparatus 200. As a result, according to the projection type display apparatus 200 of Embodiment 2, it becomes possible to thin (i.e., to reduce the depth dimension of) the projection type display apparatus 200.

Moreover, in the projection type display apparatus 200 of Embodiment 2, the depth dimension D2 of the hologram element 52 does not change even when the surface area of the hologram element 52 is increased, and therefore the distortion aberration can be excellently corrected.

Furthermore, in the projection type display apparatus 200 of Embodiment 2, it becomes possible to eliminate the cause of increase in the cost due to the manufacturing of the power mirror having a complicated shape such as an aspheric surface or a free surface, and therefore the manufacturing cost can be reduced.

As described above, according to the projection type display apparatus of Embodiment 2, it becomes possible to reduce the depth dimension of the projection type display apparatus with a simple configuration, without degrading the image quality.

The features of Embodiment 2 other than those described above are the same as Embodiment 1.

### Embodiment 3

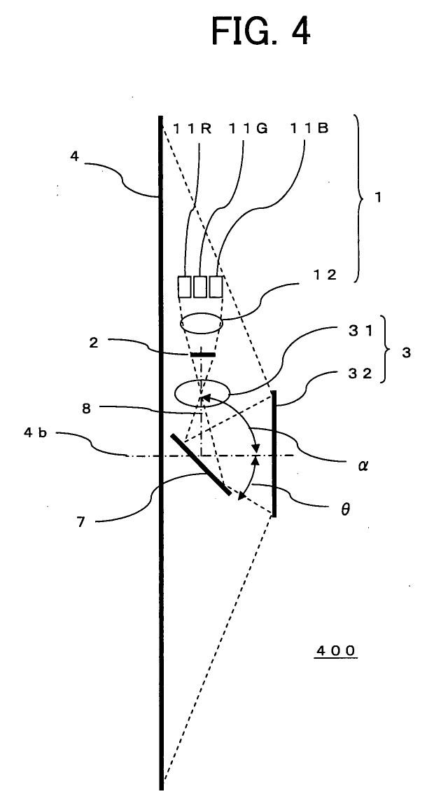

FIG. 4 is a top view schematically showing a configuration and a light path of a projection type display apparatus 400 according to Embodiment 3 of the present invention. In FIG. 4, components that are the same as or corresponding to those shown in FIG. 1 are assigned the same reference numerals.

As shown in FIG. 4, the projection type display apparatus 400 of Embodiment 3 has a planar reflection surface 7 on a light path from the refraction type optical system 31 to the hologram element 32. The illumination device 1 (including the light sources 11R, 11G and 11B and the illumination optical system 12), the modulation element 2 and the refraction type optical system 31 are disposed on the same side as the hologram element 32 with respect to a plane including the screen 4 and perpendicular to a normal line 4b of the screen 4.

The planar reflection surface 7 has a function to reflect the light emitted from the refraction type optical system 31 toward the hologram element 32, so as to bend the light path. In this regard, an angle θ (degrees) between the normal line 4b of the screen 4 and the planar reflection surface 7 and an angle α (degrees) between an optical axis 8 of the refraction optical system 31 and the normal line 4b of the screen 4 satisfy the following relationship:
θ=90−α/2

In consideration of the reduction of the depth dimension and the design of the projection type display apparatus, it is preferable that the illumination device 1 (including the light sources 11R, 11G and 11B and the illumination optical system 12), the modulation element 2 and the refraction type optical system 31 are disposed on the same side as the hologram element 32 with respect to a plane including the screen 4 and perpendicular to the normal line 4b of the screen 4. Therefore, the angle α is preferably smaller than or equal to 90 degrees, i.e., the angle θ is preferably smaller than or equal to 45 degrees.

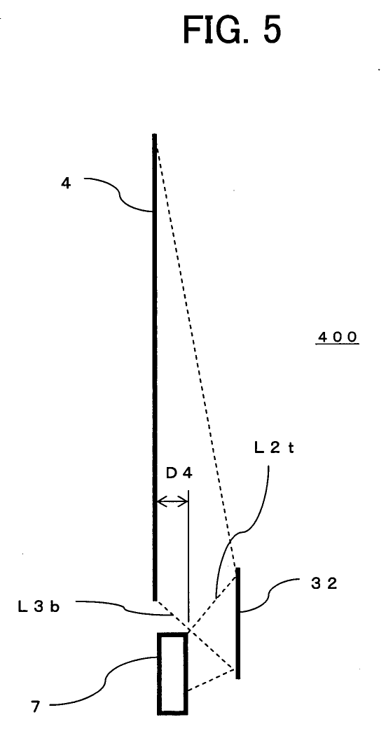

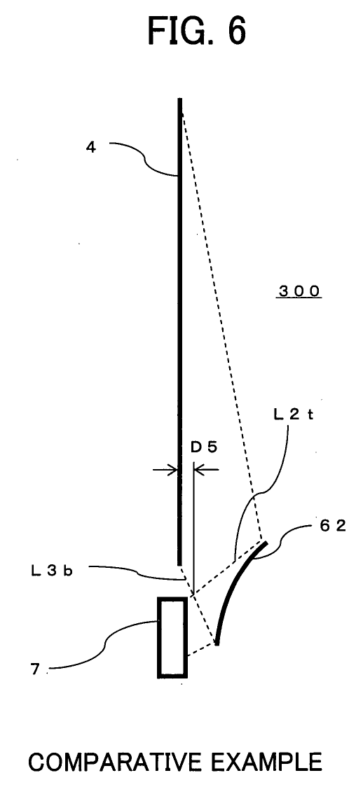

FIG. 5 is a side view schematically showing the configuration and the light path of the projection type image display apparatus 400, as seen from the side. For comparison, FIG. 6 shows a projection type image display apparatus 400 of Comparative Example (FIG. 3) in a similar manner to FIG. 5. In FIGS. 5 and 6, components that are the same as or corresponding to those of FIGS. 1 and 3 are assigned the same reference numerals.

In the Comparative Example shown in FIG. 6, among principal rays emitted by the planar reflection surface 7 toward the power mirror 62, the arbitrary principal ray from the power mirror 62 reaching the top end of the screen 4 is referred to as the principal ray L2t, and the arbitrary principal ray from the power mirror 62 reaching the bottom end of the screen 4 is referred to as the principal ray L3b. Further, the horizontal distance from the intersection point between the principal ray L2t and the principal ray L3b to the screen 4 is referred to the horizontal distance D5.

The position and the angle of the planar reflection surface 7 must be adjusted so that the depth dimension of the planar reflection surface 7 in the direction of the normal line 4b of the screen 4 is in the range of the horizontal distance D5. When the planar reflection surface 7 exceeds the horizontal distance D5 and is positioned on the power mirror 62 side, the principal ray L3b interferes with the planar reflection surface 7, so that a shadow appears on the lower side of the screen 4. In contrast, when the planar reflection surface 7 exceeds the horizontal distance D5 and is positioned on the screen 4 side, a part of the planar reflection surface 7 protrudes frontward from the screen 4. In such a case, the depth dimension of the projection type display apparatus increases, and the design thereof is not preferable.

In the case of the projection type display apparatus 300 of Comparative Example shown in FIG. 6, as the angle of view increases, the power mirror 62 becomes closer to the screen 4, and the emitting position of the principal ray L3b from the power mirror 62 becomes closer to the screen 4. Therefore, the incident angle of the principal ray L3b on the screen 4 becomes large. As a result, the intersection point between the principal ray L3b and the principal ray L2t becomes closer to the screen 4, so that the horizontal distance D5 decreases. In this case, if the planar reflection surface 7 is disposed so as not to cause the interference between the principal ray L3b and the planar reflection surface 7, the planar reflection surface 7 protrudes from the screen 4. Further, the depth dimension of the reflection surface 7 can be reduced by increasing the angle e, but it may cause the interference between the refraction type optical system 31 and the power mirror 62, the interference between the refraction optical system 31 and the principal ray L3b, or the like.

In contrast, according to the projection type display apparatus 400 of Embodiment 3 shown in FIG. 5, when the projection type display apparatus 400 is assumed to have the same depth dimension as the projection type display apparatus 300 of Comparative Example shown in FIG. 6, the emitting position of the principal ray L3b from the hologram element 32 is far from the screen 4 since the hologram element 32 has the planar shape. Therefore, the horizontal distance D4 from the intersection point between the principal ray L2t and the principal ray L3b to the screen 4 can be longer than the horizontal distance D5 (FIG. 6). Accordingly, it becomes easy to dispose the planar reflection surface 7 within the horizontal distance D4. At the same time, the allowable range of the angle of the planar reflection surface 7 increases, and therefore the flexibility in the positioning of the illumination device 1, the refraction type optical system 31 and the like in the casing increases.

Generally, when the F-number of the projection optical system is small, the projected image becomes bright, but it becomes difficult to ensure imaging performance. In contrast, when the F-number of the projection optical system is large, the projected image becomes dark, but it becomes easy to ensure imaging performance. In a general image display apparatus using a lamp as a light source, the F-number of the projection optical system is set to approximately 2.4 in consideration of the limitation of the light modulation element and the balance between the imaging performance and the brightness of the projected image.

In contrast, when the laser light source is used, the laser beam has small divergent angle and high directivity, and therefore the F-number of the projection optical system can be large (for obtaining the projected image having the same brightness), compared with the case where the lamp is used as the light source. As described above, when the F-number of the projection optical system becomes large, it becomes easy to ensure the imaging performance, and therefore it becomes possible to miniaturize the projection optical system even when the projection optical system provides the same optical performance.

When the refraction type optical system and the hologram element are miniaturized, the position of the principal ray L2t becomes low as shown in FIG. 5, and therefore the intersection point between the principal ray L2t and the principal ray L3b becomes far from the screen 4, with the result that the horizontal distance D4 increases. Therefore, for the same reason as described above, the flexibility in the positioning of the planar reflection surface 7 further increases.

Moreover, in the case where the horizontal distance D4 is sufficiently larger than the depth dimension of the planar reflection surface 7 due to miniaturizing of the projection optical system, it becomes possible to position the hologram element 32 close to the screen 4 without causing the interference between the principal ray L3b and the planar reflection surface 7. Therefore, it becomes possible to further thin the projection type display device.

When a lamp is used as the light source of the projection type optical apparatus, the position of the lamp is largely determined so as to ensure easy replacement of the lamp, irrespective of the configuration of the illumination optical system and the projection optical system. Therefore, the configuration and the position of the illumination optical system are limited. Particularly, in a thin projection type display apparatus, the inner space of the casing is also limited, and therefore the positioning of the light source and the illumination optical system becomes difficult.

In contrast, the light (laser beam) emitted by the laser light source has high parallelism, and therefore the light can be collected using lens or the like. Therefore, when the laser light source is used, the light (laser beam) emitted by the laser light source can be efficiently introduced into optical fibers, transmitted through the optical fibers, and introduced to the illumination optical system. The optical fibers, made of glass or plastic, can be freely bent in an allowable range. Therefore, the laser light source can be freely positioned in an empty space in the casing without being limited by the positions of the illumination optical system and the projection optical system. In FIG. 4, the laser light sources 11R, 11G and 11B are disposed on the same side as the illumination optical system 12 with respect to the center of the screen 4. However, if the positioning space is limited, the laser light sources 11R, 11G and 11B can be disposed on the side opposite to the illumination optical system 12 with respect to the center of the screen 4. In this case, an incident end portion (on the laser light sources 11 side) and an emitting end portion (on the illumination optical system 12 side) of the optical fibers are fixed, but the intermediate portion of the optical fibers can be freely drawn in the empty space in the casing.

As described above, according to the projection type display apparatus 400 of Embodiment 3, the flexibility in the positioning of the respective components increases, and a thinner projection type display apparatus can be accomplished.

In the above description of Embodiment 3, the hologram element has been described as the light-reflection type, but it is possible to obtain the same advantage on the same principle even when the light-transmission type hologram element is used.

While the preferred embodiments of the present invention have been illustrated in detail, it should be apparent that modifications and improvements may be made to the invention without departing from the spirit and scope of the invention as described in the following claims.

What is claimed is:

1. A projection type display apparatus comprising:
an illumination device including a light source;
a light modulation element to which image signal is inputted and which modulates a light from said illumination device according to said image signal;
a projection optical system which projects a modulated light from said light modulation element in an enlarged manner, and
a screen onto which a projected light from said projection optical system is projected so that an image is displayed thereon,
wherein said projection optical system comprises:
a refraction type optical system which refracts said modulated light from said light modulation element, and
a hologram element disposed on a position remote from said screen and shifted in a direction parallel to said screen from a center of said screen, said hologram element projecting said modulated light having passed through said refraction type optical system onto said screen so that a light ray of the center of said modulated light is inclined with respect to a normal line of said screen.

2. The projection type display apparatus according to claim 1, wherein said light source of said illumination device includes a laser light source.

3. The projection type display apparatus according to claim 1, wherein said hologram element has a planar shape.

4. The projection type display apparatus according to claim 1, wherein said hologram element is disposed parallel to said screen.

5. The projection type display apparatus according to claim 1, wherein said hologram element is a light-reflection type hologram element.

6. The projection type display apparatus according to claim 1, wherein said hologram element is a light-transmission type hologram element.

7. The projection type display apparatus according to claim 1, wherein a planar reflection surface is disposed on a light path from said refraction type optical system to said hologram element,
wherein said illumination device, said light modulation element and said refraction type optical system are disposed on the same side as said hologram element with respect to a surface including said screen and perpendicular to a normal line of said screen.

8. The projection type display apparatus according to claim 1, wherein said screen is a light-transmission type screen.
